(19) United States
(12) Patent Application Publication
(10) Pub. No.: US 2016/0113473 A1
(43) Pub. Date: Apr. 28, 2016

(54) Quick Disconnect Swivel Adjoined Lock Mechanism

(71) Applicants: Simon Ralph Cassar, Corralitos, CA (US); Alex Pozzi, Winston-Salem, NC (US)

(72) Inventors: Simon Ralph Cassar, Corralitos, CA (US); Alex Pozzi, Winston-Salem, NC (US)

(21) Appl. No.: 14/526,269

(22) Filed: Oct. 28, 2014

(51) Int. Cl. A47L 13/24; A47L 13/254; A46B 17/02; F16C 11/10; F16C 11/12

(52) U.S. Cl. CPC A47L 13/24; F16C 11/103; F16C 11/12; A46B 17/02; A47L 13/254

(57) ABSTRACT

An adjoined shock absorbing non-breakable two-sectional swivel type attachment in which one section is made from a unitary shock absorbing flexible elastomer material absorbing shocks and allowing for a quick release clamp mechanism and the other section is adjoined by an axis that retains the handle allowing for swivel movement. The adjoined two piece attachment can be locked via a pin with protruding lock lever that can be rotated in either the locked non-swiveling position that engages into a lock cavity housing or rotated 90 degrees and allow for the connector to freely swivel. The combination of a non-removable lockable pin allows for easy transition between the locked and swivel position thus a quick release unitary flexible clamp mechanism adjoined to a swivel mechanism allows for small tools, cleaning devices, such as scrub brushes, wall washers, abrasive pad holders, etc. or any other type of device requiring a non-breakable quick disconnect device to occur that can be easily engaged and disengaged allowing tools, etc. to also be used as a handheld device. When the swivel mechanism is in the locked fixed non-swiveling position, the shock absorbing axis and its supporting upper and lower members, that are retained by the lock pin, flexes and absorbs shocks due to its elastomers flexible properties and eliminates breakage when hitting stationary objects. Furthermore, swivel type floor cleaning devices will no longer need their own swivel type connector affixed onto the cleaning head thus making the cleaning products more cost efficient.

### BACKGROUND OF THE INVENTION

1. Background of the Invention

The present invention relates to how an adjoined two piece swivel connector is locked and unlocked with one of the two pieces being made from a soft elastomeric material that collapses when inserted into the jaws of a harder material and then a hard pin is inserted that allows for rotation into the locked and unlocked position. The softer elastomer material lower member of the connector when abused flexes and absorbs shocks thus making it unbreakable In particular products that take harsh abuse like cleaning tools for scrubbing, dust mopping, or a sweeping apparatus and in particular to scrub brushes or applications where material is being removed by an apparatus. The present invention relates to a swivel joint two piece unitary flexible molded elastomer attachment that allows multiple cleaning apparatuses to be attached and detached for cleaning purposes. The new innovation allows for easy engagement and disengagement of the swivel mechanism to the cleaning head apparatus thus eliminating costly swivel joints that are adjoined to prior art swivel joint type cleaning apparatuses. In addition, the swivel type cleaning head apparatuses can be used as a handheld cleaning apparatus when not engaged with the swivel type joint quick release mechanism. In addition, using an elastomer material for the shock absorbing symmetrical jaws that encompasses the swivel axis allows for the jaws to be preloaded thus the swivel does not become loose.

2. Description of Prior Art

The standard swivel type floor cleaning apparatus has two primary components. The first component is the floor cleaning head such as a flat mop, dust mop, wall washer, grout cleaner, scrub brush, or abrasive pad holder. All these floor-cleaning apparatuses have an adjoined embodied swivel type connector that is permanently attached to the cleaning apparatus making them very costly. The second primary component of floor cleaning apparatuses is the handle which is usually a cylindrical pole that is inserted into the swivel joint handle connector. The floor handle connector is only removable by unthreading the lock nut or twisting the handle out of the handle connector leaving the swivel joint mechanism attached to the cleaning apparatus. The combination of the unitary elastomer quick disconnect and rotating swivel type mechanism permits all floor cleaning apparatuses to be pushed and pulled by exertion of a force on the handle and flex to absorb damaging impacts when coming in contact with obstacles. Prior art has also addressed the issue of loose swivels as in U.S. Pat. No. 4,763,377.

One significant problem with swivel type floor cleaning apparatuses is the lock mechanism that stops the connector from swiveling. Also, prior art swivel type apparatus eventually breaks around the swivel type axis and/or upper and lower support members supporting the axis when either hitting stationary object or abuse. Also, when the swivel type axis is jammed or locked into a non-swiveling static position allowing only one position to be retained, the leverage caused by the jam/stop causes swivel type attachments to break. This new innovation is made from shock absorbing flexible elastomer material that can absorb abusive shocks. Also, prior art U.S. Pat. No. 8,286,294 has the clamp mechanism flex to adjoin onto the rotating axial shaft and a removable pin that has to be removed and reinstalled. The new innovation has an internal lock pin that is not removed and instead just lifted up and rotated to allow the swivel and non-swivel mode. Also, this new innovation has the axial shaft to collapse and flex inwards thus allowing the harder handle end of the connector to encapsulate the axial shaft and then insert the lock pin, made from harder material, thus the upper and lower halves are adjoined and cannot come apart or inadvertent disengage unless the lock pin is completely removed from the apparatus. Therefore, a significant need exists to improve upon the previous patents that allows for a shock absorbing elastomeric flexible swivel connector that when abused or placed in a fixe non swiveling position flexes and absorbs shocks thus eliminating breakage and negotiates around obstacles that would have otherwise broken or damaged the handle or swivel type handle connector. Also, the new innovation allows for a more cost effective non-loosening swivel type floor connector that can be easily detached from multiple cleaning devices thus allowing the cleaning apparatus to also be used for hand operations thus reducing cost, space and increasing durability. Lastly, the new invention allows for the lock pin to remain in the housing and to lock or unlock the swivel mechanism can now be easily done by lifting up the lock pin and rotating the lock pin and pushing it back into the retaining housing. The lock pin also allows the invention to be used on lobby type push brooms. Also, this new method eliminates any potential disengaging the upper and lower adjoined parts due to the hard pin ensuring the two adjoined halves cannot come apart.

### SUMMARY OF THE PRESENT INVENTION

The present invention a shock absorbing unbreakable swivel type apparatus that is affixed at the location between a handle and head of the floor cleaning apparatus to provide a flexible member at the junction where the floor cleaning handle apparatus is attached to the floor cleaning apparatus head. One significant problem is swivel type apparatuses eventually break around the swivel type axis and/or upper and lower support structure supporting the axis, or they become disengaged, or the two pieces that are adjoined together around the swivel axis come apart because the jaws that encapsulate the axis can easily open up and disengage when abused. Also, when the swivel type axis is jammed or in a locked non-swiveling position allowing only one position the be retained, the leverage caused by the swivel mechanism being locked or jammed causes non-shock absorbing jaws, upper and/or lower members around rotating axis or axis shaft/pin and its surrounding area to easily break when the floor cleaning apparatus head comes in contact with a stationary object. The new innovation allows for a lock pin to be inserted into a flexible material axial shaft thus stop the two halves from coming apart when abused. The swivel joint apparatus will flex approximately 3-76 degrees deflection in the lateral and/or vertical axis and also the longitudinal axis in relation to the floor cleaning apparatus. A swivel cleaning attachment wherein said clamping member rotates around said shock absorbing axis member and adjoined symmetrical jaws that can be jammed to stop the swiveling motion by way of a protruding lock pin that resides inside the axial shaft that has a protruding lever that can engage into a lock cavity on the opposing half of the swivel connector allows the joint to lock into a non-swiveling position or stated to prevent swiveling around the lateral axis, however still allowing for some flexing due to the flexible material nature of the swivel joint when the cleaning apparatus comes in contact with stationary objects to prevent breakage. To disengage the protruding lock pin, the lock pin is lifted up out of the retaining lock cavity housing and rotated to the opposite side of the swivel joint that is contained in a cavity storage housing thus allowing the joint to swivel. When in the locked position said clamping member and said shock absorbing lower member and axis member flexes to eliminate breakage when hitting stationary objects thus allows the handle to negotiate around such objects into the two scissor like members when in the free rotational swivel position. It is therefore an object of the present invention to provide an unbreakable flexible shock absorbing swivel type apparatus that can easily disengage and engage from tools that can also be easily locked into position or unlocked by easily rotating the protruding lock pin and locking the swivel movement to not rotate thus also being made from a flexible material that can absorb damaging impacts when abused. Also, the new innovation allows all tools to be able to be held by hand since the apparatus is positioned permanently on the handle and not on the tool itself thus allowing the apparatus to cost less to manufacture than standard swivel type connectors.

Further novel features and other objects of the present invention will become apparent from the following detailed description, discussion and the appended claim, taken in conjunction with the drawings.

### BRIEF DESCRIPTION OF THE DRAWINGS

Referring particularly to the drawings for the purpose of illustration only and not limitation, there is illustrated:

FIG. 1 is a perspective view of the preferred embodiment of the present invention floor cleaning handle apparatus with the swivel joint in the locked position and attached to the floor scrub brush of the preferred embodiment of the present invention floor cleaning handle apparatus illustrating the slight flexing movement of the attachment when in the fixed locked static position and in contact with a stationary object.

FIG. 2 is a perspective view of the preferred embodiment of the present invention floor-cleaning handle apparatus attached to the floor scrub brush.

FIG. 3 is a cross-sectional view looking up taken along line 3-3 of FIG. 1.

FIG. 4 is a perspective view of the preferred embodiment of the present invention floor cleaning handle apparatus in the unlocked position allowing the mop head to swivel up to 90 degrees on either side and attached to the floor scrub brush of the preferred embodiment of the present invention.

FIG. 5 is a side elevational view of the preferred embodiment of the present invention floor cleaning handle apparatus.

FIG. 6 is a side elevational view of the lock pin apparatus.

FIG. 7 is a perspective view of the lower half of the two adjoined part apparatus that contains the jaw mechanism.

FIG. 8 is a perspective view of the upper half of the two adjoined part apparatus that holds the handle.

FIG. 9. Is a side view of the lower half of the two adjoined part apparatus.

FIG. 10 is a side view the upper half of the two adjoined part apparatus that holds the handle.

FIG. 11 is an enlarged view of Z-Z in FIG. 9.

FIG. 12 is an isometric view of the floor cleaning handle attachment in its entirety.

FIG. 13 is an cross sectional view looking down taken along line 10-10 of FIG. 5.

### DETAILED DESCRIPTION OF THE PREFERRED EMBODIMENT

Although specific embodiments of the invention will now be described with reference to the drawings, it should be understood that such embodiments are by way of example only and merely illustrative of but a small number of the many possible specific embodiments which can represent applications of the principles of the invention. Various changes and modifications obvious to one skilled in the art to which the invention pertains are deemed to be within the spirit, scope and contemplation of the invention as further defined in the appended claims.

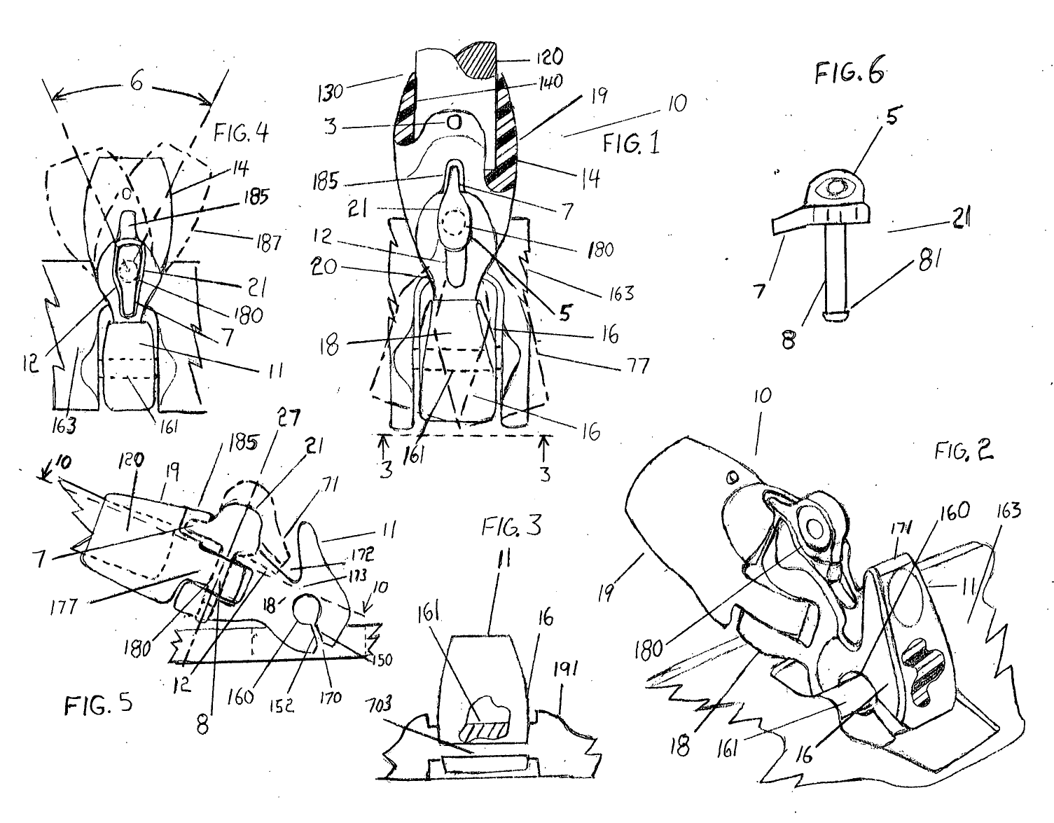

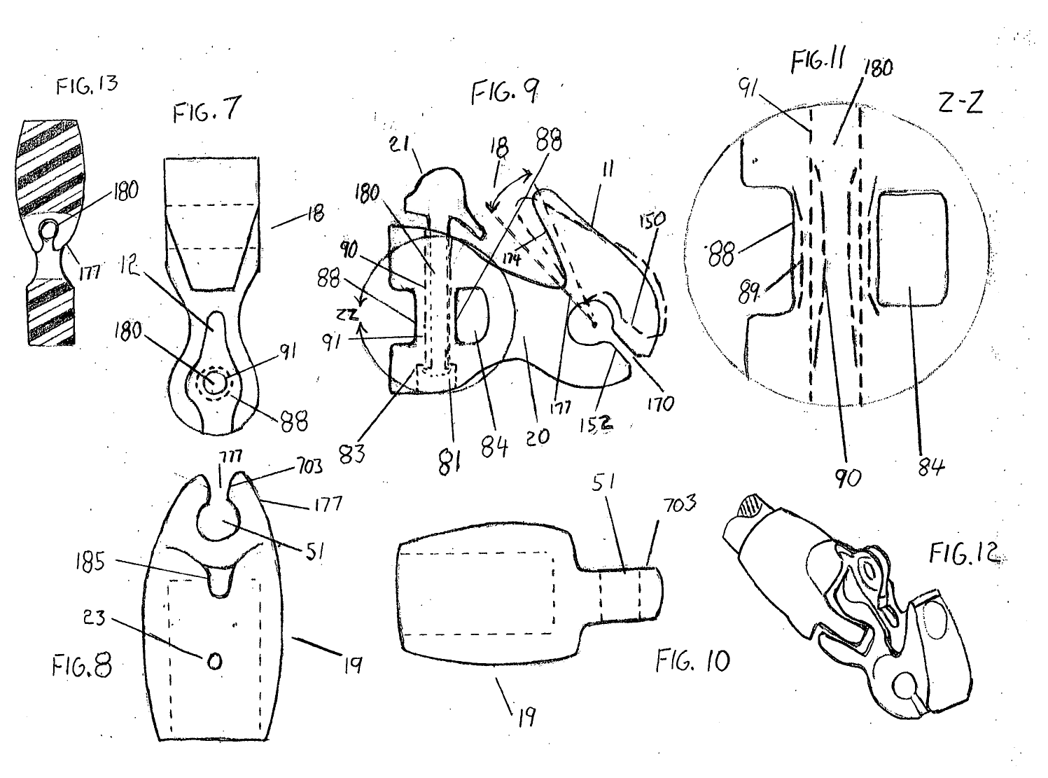

In the preferred embodiment, the lower half of the two adjoined part apparatus 18 that contains the jaw mechanism in FIG. 1 is made of any flexible substance with memory such as any elastomer material such as rubber, urethane, nylon, plastic, titanium, or polyvinyl. It is also within the spirit and scope of the present invention for the attachment to be made of flexible but strong plastic such as Mylar, polypropylene or any other flexible material exhibiting the required shock absorbing flexible characteristics. The upper half of the two adjoined part apparatus 14 in FIG. 1 is made of a harder substance such as Polypropylene, ABS, Urethane, etc. Referring to FIG. 1, there is shown at 10 the present invention swivel connector for multiple cleaning apparatuses with lock pin 21 protruding lever 7 engaged into lock cavity housing 185 that resides in the upper support member 19 to lock the swivel joint from swiveling around axis 180, thus not allowing the apparatus to rotate and instead to be locked into a fixed one position, or stated otherwise, to prevent swiveling around the lateral axis, however still allowing for some flexing due to the flexible material nature of the swivel joint when the cleaning apparatus comes in contact with stationary objects to prevent breakage. Either and/or both upper support member 19 and/or lower support member 18 is made from a flexible shock absorbing elastomeric material thus allowing the approximate mid-section 20 to bend or flex allowing lateral flexing of longitudinal section and handle member between the range of approximately 3 degree.-75.degree when being abused or hitting a stationary object thus eliminating damage to obstacles or apparatus or handle breakage; whereby shock absorbing flexible mid-section allows handle member to maneuver said head member to be pushed back and forth while at the same time allows said handle member to move laterally relative to said head member and when said head member comes in contact with an object thereby prevents said handle member from lateral movement such that said flexible insert member prevents said handle member from damaging obstacles or cleaning head apparatus. Phantom lines 77 illustrating the flexing movement allowing the connector to become shock absorbing can be seen with protruding lever 7 engaged into lock cavity housing 185 thus jamming and stopping the upper member 19 and lower member 18 from swiveling around jointed axis 180. Thus shown is clamp mechanism 16 and support frame 161. When lock pin 21 protruding lever 7 is lifted up and rotated and stored into unlock cavity housing 12, the lower support member 18 can rotate around axis 180 beyond full 180 degrees deflection to negotiate around obstacles. It should be noted that the rotating axis is not limited to the type of axis used. For example the rotating axis member 180 could be an integrally unitary molded shaft that makes up the lower support member 18 or could be a bolt, pin, rivet, fastener etc. In the preferred molded embodiment, the apparatus 10 comprises a longitudinal section 14 and a lateral section 16 that are interconnected by axis 180 as shown in cross sectional view FIG. 10. In general appearance, the two-piece molded inserts look like an extended Roman numeral one with the top portion, item 130, being the receptacle to hold the handle 120. The handle is supported by the attachment body 14 that is a recessed cavity to hold the floor handle. Accordingly the upper sleeve portion of the cylindrical sleeve section 130 includes an axial bore 140 having a uniform dimension so as to receive therein the transverse dimension of the handle 120. The thickness of the material-encapsulating handle 120 is sufficient to not crack when impact to the head of the floor cleaning apparatus occurs. The upper sleeve section 130 has a diameter to tightly receive, in a generally slip-fit relationship, the transverse dimension of the handle to frictionally retain the handle therein. It is not limited to the intent of this invention as to how the handle is retained and can be either threaded or attached by a bolt, screw or rivet as shown in attachment hole 3. The overall configuration of the lower support member 18 as it joins to the floor cleaning apparatus frame support clamp recess cavity 160 resembles an inverted “t” with the mid portion of the vertical leg being thin in the middle and the lower portion of the leg extending outboard in both the left and right lateral directions to form the clamp mechanism 16 as shown in FIG. 1. The clamp mechanism 16 when attached to the floor cleaning head support frame 161 that is adjoined to the floor cleaning apparatus head 163. Referring to FIG. 2, there is illustrated in a perspective view the relationship between the perspective floor cleaning apparatus head 163 and floor cleaning handle attachment 10. The present invention includes a two sectional connector adjoined together through axis shaft 180. The lower support member 18 comprising of a clamping mechanism section and an upper support member 19 comprising of the handle support hole. Both sections are a one piece unitary molded part adjoined only by way of axis 180. The floor cleaning apparatus head support frame 161 is encapsulated by the clamp mechanism 16 and supported by the lateral recess cavity 160. The support frame 161 has an approximate diameter between 0.15 and 0.60 of an inch. The larger diameter allows for the cleaning head to be a unitary one piece injected molded apparatus. The lower support member 18 adjoins the clamp mechanism 16. When the clamp mechanism 16 is disengaged from the support frame 161 the cleaning apparatus head 163 or cleaning head devices can be used as a handheld cleaning device.

Referring to FIG. 3. Illustrates the clamp mechanism 16 and the protruding push lever 11 that allows leverage to open the jaws 703 of the clamp that encapsulate floor cleaning apparatus head support frame 161.

Referring to FIG. 4. Illustrates the movement of the swivel connector Phantom lines 187 and shown in either direction 6 when in contact with a stationary object in the non-locked swiveling position. The floor cleaning attachments lower support member 18 can rotate around the jointed axis shaft 180 over 90 degrees in relation to the floor cleaning handle upper support member 19. The reason for over 90 degrees is due to its flexible shock absorbing elastomer material. Lock pin 21 protruding lever 7 is shown being stowed in non-lock housing cavity 12. Floor cleaning apparatus 163 and adjoined frame support 161 and release lever 11 shown.

Referring to FIG. 5. There is illustrated the unitary elastomeric clamp mechanism. The elastomer hinge clamp mechanism 160 has an upper jaw 152 and lower jaw 150 with an opening slotted jaw 170 that is angled that extends laterally. Chamfered opening 170 allows for access to retaining cavity 160 that encapsulates firmly but loosely supports the floor cleaning apparatus support frame in order to pivot along the lateral axis. The upper clamp 152 remains rigid while the lower clamp 150 pivots around the lateral axis at cavity 172. Protruded lever 11 when depressed displaces cavity 172 allowing for lower clamp 150 to move forward in relation to upper clamp 152 allowing for opening 170 to enlarge as shown in FIG. 9 with Phantom 190. Elastomer hinge 173 allows for a preload to occur around the clamping mechanism and can be opened by compressing and expanding the flexible elastomer material in the elastomer hinge. The peripheral side arm type jaws 177 wrap around the axis shaft 180. Lock pin 21 protruding lever 7 is stowed and engaged into lock cavity housing 185 and locks apparatus from swiveling around the axis 180. Lock pin 21 is shown lifted up Phantom 71 and rotated around axis 27 and placed in unlock cavity housing 12 thus allowing apparatus to swivel freely. Lock pin shaft 8 is shown inside axis 180 and thus eliminating the axis shaft walls to collapse thus stopping the cleaning handle support 19 and lower support member 18 adjoined pieces from disengaging or coming apart.

Referring to FIG. 6. there is illustrated the limited non flexing engineered elastomer lock pin 21 that has an upper grab hold 5 that extends our for easy finger and thumb grabbing the pin and lifting up and rotating the pin to the unlock or locked the apparatus swivel or non-swivel position respectfully. The lock pin 21 has a protruding lever 7 that engages in the lock housing cavity to stop swivel movement. Lock pin shaft 8 is made from harder elastomeric material thus when inserted into the axis shaft 180 in FIG. 9 the walls of the axis shaft do not collapse as shown in FIG. 11 when the lower 18 and upper 19 are adjoined together and thus the two halves of the apparatus are retain together. Lock pin shaft lip 81 allows for the lock pin 21 to stay in the axis shaft 180 in FIG. 9 and is retained by retaining lip 83 also in FIG. 9. The protruding lever 7 that engages into the lock housing lever can be recessed or have an edge along the side of the walls of the lock housing to stop the lever 7 from lifting out inadvertently. Thus the pressure, load and for friction between the side walls of the lock housing and protruding lip 7 stops the protruding lever 7 from coming out of the lock housing.

Referring to FIG. 7. Is a perspective view of lower support member 18 and unlock cavity housing 12. Axial shaft 180 and axial shaft inner wall 191 and axial shaft outer wall 88. The lower support member is made from flexible elastomeric material thus allow the jaw mechanism to open and close as shown FIG. 9 and axial shaft outer walls to flex inwards per FIG. 11.

Referring to FIG. 8. Is a perspective view of upper support member 19 that is made from hard limited flexing elastomer material thus have limited movement of the front face of the peripheral symmetrical arm type jaws front face 703 are either beveled or and/or radius for easy insertion onto axial shaft outer wall 88 that is retained by peripheral symmetrical arm type jaws 177 around FIG. 7 axial shaft outer wall 88 that is housed in axial housing 51 when the lower support member 18 in FIG. 7 and upper support member 19 are adjoined together. lock cavity housing 185 and retaining hole for handle attachment screw 23 is shown.

Referring to FIG. 9. there is shown a side view of lower 18 that is made from a flexible elastomer material. The flexible elastomer material allows for Lock pin 21 shaft lip 81 to be larger in diameter than axial shaft 180 thus has free movement once beyond axial shaft retaining lip and therefore the lock pin can freely move up and down within the shaft but is retained from coming out due to the interference fit between lock pin shaft lip 81 and retaining lip 83 and is shown illustrated the two coming into contact and thus not allowing lock pin 21 from coming out of the axial shaft 180. The flexing movement around the horizontal axis in the approximate mid-section 20 when being either pushed down on the handle or pulled up excessively by exertion of a force thus the shock absorbing flexing of the approximate mid-section 20 prevents said handle member, swivel attachment, and/or floor cleaning apparatuses from being damaged thus becoming unbreakable. The flexible shock absorbing elastomeric material thus allows the approximate mid-section 20 to bend or flex allowing horizontal flexing of longitudinal and handle member between the range of approximately 3.degree.-75.degree when being abused or hitting a stationary object thus eliminating damage to obstacles or apparatus or handle breakage; whereby shock absorbing flexible mid-section 20 allows handle member to retain sufficient stiffness but when excessive downward force is applied the said mid-section 20 will flex and absorb the shock when a force is applied by a downward force thereby prevents said handle apparatus and/or handle from damage. There is illustrated the movement of the elastomer hinge clamp mechanism between upper and lower clamps 150 and 152 when force is applied to protruded lever 11 on side 174 causing expansion and compression on elastomer hinge 177. The axial shaft lock pin is inserted into an axial shaft made from flexible elastomeric material that once inserted stops the axial shaft from collapsing with encapsulating jaws are being forced off due to abuse of apparatus thus axial Inner wall and outer axial wall are collapsing inside thus reducing the diameter of axial shaft this collapsing of the inner and outer walls allows for the retaining gap of the opposing upper member peripheral symmetrical arm type jaws front face to be inserted around the lower member axial shaft thus adjoining both the upper support and lower support members and then the harder material lock pin is inserted into the axial shaft and thus the walls of the axial shaft cannot collapse thus retaining the two halves together when abused and not separating and coming apart.

Referring to FIG. 10. there is illustrated a side view of upper support member 19 and axial housing 51 and peripheral symmetrical arm type jaws front face 703.

Referring to FIG. 11. there is illustrated a blow up view of the axial shaft 180 minus the lock pin 21 shown in FIG. 9. Axial Inner wall 91 and outer axial wall 88 are shown collapsing inside thus reducing the diameter of Axial shaft 180 via Phantom lines outer wall 89 and inner wall 90. This collapsing of the inner and outer walls allows for the retaining gap 177, between peripheral symmetrical arm type jaws front face 703 in FIG. 8, to allow Axial shaft to be inserted into FIG. 8 axial housing 51 thus adjoin both the upper support 19 and lower support member 18 parts together as shown in FIG. 2.

Referring to FIG. 12. there is an isometric illustration of the attachment in its entirety. Referring to FIG. 13. there is illustrated a cross sectional view of the attachment in its entirety. The peripheral symmetrical side arm type jaws 177 are wrapped around the unitary collapsible axis shaft 180. Once the lock pin is installed into the axial shaft 180 the walls will not collapse thus retaining both upper and lower support members.

What I claim as my invention is:

1. A floor cleaning apparatus comprising:
a cleaning head connected to a two piece unitary flexible shock absorbing unbreakable molded elastomeric swivel joint;
the cleaning head has a top mounting surface and a bottom cleaning surface, the top mounting surface has a support frame extending along the longitudinal axis of the head;
the two piece swivel joint comprises a lower support member and an upper support member, the lower support member has a first end and a second end, the first end of the lower support member comprises a unitary flexible transverse clamping section having an upper jaw and a lower jaw which forms an elastomeric hinge that is made from a compressible expandable elastomer material to allow preload gripping force thus encapsulating the support frame, the upper and lower jaws form a slotted opening which interconnects with a retaining cavity for receiving the support frame of the cleaning head, the lower jaw has a push lever integrally formed therewith, such that when the push lever is forced inwardly, the lower jaw is moved away from the upper jaw for allowing the support frame to be inserted through the slotted opening and secured within the retaining cavity when the push lever is released; and the upper support member has a first end and a second end, the first end of the upper support member has a longitudinal attachment section having an axial bore with an open end to receive a longitudinal handle, the handle has one end press fitted from the open end and secured within the axis bore of the upper support member, the second ends of the lower support member and the upper support are connected via a pivoting member forming a universal joint, to allow for rotation around a lateral axis, the upper and lower support members are made from an elastomeric flexible material so that when the cleaning apparatus comes in contact with stationary objects or is abused, the two piece unitary swivel joint will flex and prevent damage to the handle, cleaning head, and joint.

2. The floor cleaning apparatus of claim 1 further comprising of a lock pin and protruding lever that engages into a lock cavity housing that jams the two upper and lower members thus prevent swiveling around the lateral axis thus stopping the swiveling movement to prevent swiveling around the lateral axis, however still allowing for some flexing due to the flexible material nature of the swivel joint when the cleaning apparatus comes in contact with stationary objects to prevent breakage and yet this lock pin can also be easily become disengaged by lifting up the lock pin and protruding lever out of the lock housing cavity and rotating the lever to the lower member thus allowing the swivel action around the jointed axis around the lateral axis.

3. The floor cleaning apparatus in accordance with claim 1 wherein said either and/or upper or lower support members are made out of a flexible plastic material with memory.

4. The floor cleaning apparatus in accordance with claim 1 wherein said lock pin protruding can be rotated and stored in a non-lock housing cavity for storage when in the swivel mode.

5. The floor cleaning apparatus in accordance with claim 1 wherein said either and/or upper or lower support members is made out of an elastomer plastic material.

6. The swivel joint apparatus of claim 1, wherein the upper and/or lower support members are made from an elastomeric flexible shock absorbing material which allows the upper and/or lower support member, between a flexible transverse clamping section and pivot point axis; lateral flexing of mid-section approximately 3-75 degrees when the cleaning head apparatus comes in contact with stationary objects or is abused such that the shock absorbing mid-section member prevents the handle member and or swivel attachment from breaking and thus instead absorbing damaging shocks to handle, attachment and/or cleaning head apparatuses.

7. The swivel joint apparatus of claim 1, further comprises a means to stop or interfere with the push lever and displace the cavity to stop the lower jaw to move forward in relation to the upper jaw, an axis shaft hole size for a shaft will be undersized and the flexible elastomer material that has expansion and compression properties can be adjusted via a threaded bolt and/or wing nut to adjust the amount of pre-load causing friction to eliminate wobble during a cleaning operation.

8. The swivel joint apparatus of claim 1 that axial shaft lock pin is inserted into an axial shaft made from flexible elastomeric material that once inserted stops the axial shaft from collapsing with encapsulating jaws are being forced off due to abuse of apparatus thus axial Inner wall and outer axial wall are collapsing inside thus reducing the diameter of axial shaft this collapsing of the inner and outer walls allows for the retaining gap of the opposing upper member peripheral symmetrical arm type jaws front face to be inserted around the lower member axial shaft thus adjoining both the upper support and lower support members and then the harder material lock pin is inserted into the axial shaft and thus the walls of the axial shaft cannot collapse thus retaining the two halves together when abused and not separating and coming apart.

2. A floor cleaning apparatus comprising:
a cleaning head connected to a two piece unitary flexible shock absorbing unbreakable molded elastomeric swivel joint;
the cleaning head has a top mounting surface and a bottom cleaning surface, the top mounting surface has a support frame extending along the longitudinal axis of the head;
the two piece swivel joint comprises a lower support member and an upper support member, the lower support member has a first end and a second end, the first end of the lower support member comprises a unitary flexible transverse clamping section having an upper jaw and a lower jaw which forms an elastomeric hinge that is made from a compressible expandable elastomer material to allow preload gripping force thus encapsulating the support frame, the upper and lower jaws form a slotted opening which interconnects with a retaining cavity for receiving the support frame of the cleaning head, the lower jaw has a push lever integrally formed therewith, such that when the push lever is forced inwardly, the lower jaw is moved away from the upper jaw for allowing the support frame to be inserted through the slotted opening and secured within the retaining cavity when the push lever is released; and the upper support member has a first end and a second end, the first end of the upper support member has a longitudinal attachment section having an axial bore with an open end to receive a longitudinal handle, the handle has one end press fitted from the open end and secured within the axis bore of the upper support member, the second ends of the lower support member and the upper support are connected via a pivoting member forming a universal joint, to allow for rotation around a lateral axis, the upper and lower support members are made from an elastomeric flexible material so that when the cleaning apparatus comes in contact with stationary objects or is abused, the two piece unitary swivel joint will flex and prevent damage to the handle, cleaning head, and joint.

2. The floor cleaning apparatus of claim 2 further comprising of a lock pin and protruding lever that engages into a lock cavity housing that jams the two upper and lower members thus prevent swiveling around the lateral axis thus stopping the swiveling movement to prevent swiveling around the lateral axis, however still allowing for some flexing due to the flexible material nature of the swivel joint when the cleaning apparatus comes in contact with stationary objects to prevent breakage and yet this lock pin can also be easily become disengaged by lifting up the lock pin and protruding lever out of the lock housing cavity and rotating the lever to the lower member thus allowing the swivel action around the jointed axis around the lateral axis.

3. The floor cleaning apparatus in accordance with claim 2 wherein said either and/or upper or lower support members are made out of a flexible plastic material with memory.

4. The floor cleaning apparatus in accordance with claim 2 wherein said lock pin protruding can be rotated and stored in a non-lock housing cavity for storage when in the swivel mode.

5. The floor cleaning apparatus in accordance with claim 2 wherein said either and/or upper or lower support members is made out of an elastomer plastic material.

6. The swivel joint apparatus of claim 2, wherein the upper and/or lower support members are made from an elastomeric flexible shock absorbing material which allows the upper and/or lower support member, between a flexible transverse clamping section and pivot point axis; lateral flexing of mid-section approximately 3-75 degrees when the cleaning head apparatus comes in contact with stationary objects or is abused such that the shock absorbing mid-section member prevents the handle member and or swivel attachment from breaking and thus instead absorbing damaging shocks to handle, attachment and/or cleaning head apparatuses.

7. The swivel joint apparatus of claim 2, further comprises a means to stop or interfere with the push lever and displace the cavity to stop the lower jaw to move forward in relation to the upper jaw, an axis shaft hole size for a shaft will be undersized and the flexible elastomer material that has expansion and compression properties can be adjusted via a threaded bolt and/or wing nut to adjust the amount of pre-load causing friction to eliminate wobble during a cleaning operation.
